(19) United States
(12) Patent Application Publication
(10) Pub. No.: US 2007/0008502 A1
(43) Pub. Date: Jan. 11, 2007

(54) Light quantity adjustment apparatus

(75) Inventors: Chil-Sung Lee, Suwon-si (KR); Jae-Kyung Kim, Ansan-si (KR); Sang-Min Woo, Suwon-si (KR); Dong-Won Choi, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon-si (KR)

(21) Appl. No.: 11/472,555

(22) Filed: Jun. 22, 2006

(30) Foreign Application Priority Data
Jun. 23, 2005 (KR) 10-2005-0054433

(51) Int. Cl. G03B 21/14

(52) U.S. Cl. 353/97

(57) ABSTRACT

A light quantity adjustment apparatus is disclosed. A light quantity adjustment apparatus, comprising a rotation part having an aperture for adjusting the quantity of light from a light source, a support part rotatably supporting the rotation part, a driving part rotating the rotation part left and right in a predetermined angle, a reset part for setting a base position, and a position detection part detecting the position of the rotation part, not only improves contrast ratio but also allows a clearer picture quality by adjusting the quantity of light projected from an image projection device.

### CROSS-REFERENCE TO RELATED APPLICATIONS

This application claims the benefit of Korean Patent Application No. 2005-54433 filed with the Korean Intellectual Property Office on Jun. 23rd, 2005, the disclosure of which is incorporated herein by reference in its entirety.

### BACKGROUND

1. Technical Field

The present invention relates to a light quantity adjustment apparatus, and in particular, to a light quantity adjustment apparatus which adjusts the quantity of light from the light source of an image projection device.

2. Description of the Related Art

An image projection device using Digital Light Processing (DLP), in which the mosaic phenomenon in pixels, a problem in regular Liquid Crystal Display (LCD) imaging devices, is eliminated to improve the ability to reproduce original colors, is used widely in theaters, conference rooms, and projection TV's, etc. The image projection device can be divided into a front projection device and a rear projection device according to the projection method.

The front projection device adopts the method of projecting image signals from the front, and is generally used in theaters, conference rooms, etc. On the other hand, the rear projection device adopts the method of projecting image signals from the rear of the screen. The rear projection device is commonly used in the form of projection TV's. In particular, rear projection devices are used more often than front projection devices, because of its ability to display a relatively bright image even in a bright environment.

FIG. 1 is a schematic diagram illustrating the composition of a projection TV, an example of a conventional rear projection device.

The conventional projection TV illustrated in FIG. 1 comprises a light source 81 which generates white light, a color processing device 83 which provides a particular color to the white light emitted from the light source 81, a micro display device 85 which can display a particular image using the processed light from the color processing device 83, projection lenses 87, 89 which project the image displayed on the display device 85, a mirror 93 which redirects the light from the projection lens 87, and a screen 91 which magnifies and shows the image from the projection lens 89.

The light source 81 is a lamp type light source which emits white light, and the color processing device 83 is a color filter which separates the white light into 3 colors: red, green, and blue. Also, the micro display device 85 is a digital micro-mirror device (hereafter referred to as “DMD”). Such a DMD 85 is a projection-type display using a semiconductor which controls light, developed by Texas Instruments of the United States, which has a plurality of microscopic reflective mirrors on a silicon wafer, where each reflective mirror is responsible for a single pixel structure. Due to the electrostatic action of memories (not shown) arranged in correspondence to each pixel, the inclination of the reflective mirrors is adjusted to express a picture. The reflective mirrors of the DMD 85 vibrate at a highly rapid speed and reflect light while converting the path of the incident light on/off.

However, in a conventional image projection device, there is a problem of low contrast ratio, as the projection lens 89 transmits the quantity of light from the DMD 85 as it is. The contrast ratio refers to the luminosity ratio of the white and black colors. That is, it represents the ratio of the luminosity when the color of the entire screen is set to black and the luminosity when the screen is set to white. Basically, the higher the contrast ratio, the clearer and more elaborate are the colors displayed. For example, when expressing an image of a bolt of lightning in the nighttime, a higher contrast ratio allows a clear distinction of the contrast between the bolt of lightning and the night sky.

### SUMMARY

Therefore, in order to solve the aforementioned problem, the present invention aims to provide a light quantity adjustment apparatus which can increase contrast ratio by adjusting the quantity of light transmitted from an image projection device.

Additional aspects and advantages of the present invention will be set forth in part in the description which follows and, in part, will be obvious from the description, or may be learned by practice of the invention.

To achieve the foregoing objectives, the present invention may be implemented in a variety of embodiments, some of which are described below.

A light quantity adjustment apparatus according to an embodiment of the present invention may comprise a rotation part having an aperture for adjusting the quantity of light from a light source, a support part rotatably supporting the rotation part, a driving part rotating the rotation part left and right in predetermined angles, a reset part for setting a base position, and a position detection part detecting the position of the rotation part.

The light quantity adjustment apparatus thus comprised may use control signals for controlling the quantity of light emitted from a light source by means of the rotation of apertures, to increase the contrast ratio and provide a clearer screen.

The rotation part may comprise a blade, on which the aperture is formed, and a blade arm joined with the blade on which a rotational force is applied by the driving part.

The support part may comprise a housing, and a shaft secured to the housing which rotatably supports the blade arm.

Also, the driving part may comprise a coil joined to the blade arm, and a driving magnet joined to the housing which generates a magnetic field passing through the coil.

Further, the reset part may comprise a reset magnet joined to the rotation part which interacts magnetically with the driving magnet, and the position detection part may comprise a position magnet joined to the rotation part, and a Hall sensor secured to the housing.

The light quantity adjustment apparatus thus comprised may use the reset magnet to automatically return the blade to its original position and may also identify the position of the blade by means of the position detection part, to be able to control the blade with greater precision.

A plurality of apertures having different radii of curvature may be formed sequentially on the blade. These multiple apertures having different radii of curvature allow the control of light quantity with even greater precision.

Also, it may be preferable that the surface of the blade be treated to be black and non-lustrous, in order to prevent scattered reflecting of light.

The blade arm may comprise an arm body part, a blade joint part formed on one end of the arm body part which joins with the blade, and a shaft insertion part formed on the other end of the arm body part to which the shaft is joined.

The blade arm may be formed on the lower end of the shaft insertion part, and may further comprise a position magnet mounting part on which the position magnet is mounted.

The position magnet mounting part may be inclined towards the Hall sensor, to allow a more precise measurement of the position.

The support part may comprise an adjustment bush inserted onto one end of the shaft to be positioned between the blade arm and the housing, and a spring inserted onto the other end of the shaft which applies pressure on the blade arm. These may prevent random movement of the blade arm on the shaft.

The support part may additionally comprise a securing bush; the shaft may comprise a shaft body, a screw part formed on one end of the shaft body which screw-joins the securing bush, and a shaft head formed on the other end of the shaft body; and the housing may comprise a bush insertion hole in which the securing bush is inserted, and a shaft insertion-hole in which the shaft head is inserted. Therefore, the shaft is firmly joined to the housing while screw-joined to the securing bush.

Preferably, a bearing may be positioned between the shaft insertion part and the shaft, to reduce friction between the blade arm and the shaft.

The arm body part may have a cavity part, with the coil positioned within the cavity part, and the driving part may comprise a core positioned within the coil in the rotational direction of the blade arm, and a yoke positioned adjacent to the driving magnet in a direction parallel to the core. Thus, the magnetic force lines generated by the driving magnet may be concentrated on the coil to further increase the driving power.

The housing may have a housing ledge on its inner perimeter, and by placing the core and the yoke on the housing ledge, the core and yoke may readily be joined to the housing.

The yoke may be composed of a pair of halves each comprising a yoke body part having a magnet placing part, and yoke side parts protruding perpendicularly from both ends of the yoke body part; the core may have a core body part, and core protrusion parts formed on both ends of the core body part with core ledges as boundaries; and the yoke side parts may have yoke protrusions configured to be placed on the core ledges, and yoke insertion grooves in which the core protrusion parts are inserted.

The core body part may have an arc shape, so that when the blade-arm is rotated, the core body part is prevented from obstructing the rotation of the blade arm. A damper attached to each of the yoke protrusions may not only act as a stopper for the blade arm, but may also prevent noises caused by collisions between the blade arm and the yoke. The dampers may preferably be formed of plastic resin.

As the reset magnet may be magnetized in a direction perpendicular to the driving magnet with only one pole exposed to the exterior, the blade arm may automatically return to its original state when power is not supplied from the driving part.

The position detection part may have a printed circuit board having the Hall sensor and attached to the lower portion of the housing, where the printed circuit board may be electrically connected to the coil by a flexible printed circuit board. This allows a stable connection between the printed circuit board and the coil.

Preferably, the housing may be formed by compression sintering to reduce manufacturing costs.

### BRIEF DESCRIPTION OF THE DRAWINGS

These and/or other aspects and advantages of the present invention will become apparent and more readily appreciated from the following description of the embodiments, taken in conjunction with the accompanying drawings of which:

FIG. 1 is a schematic diagram illustrating the composition of a conventional image projection device.

FIG. 2 is an assembled perspective view of a light quantity adjustment apparatus according to an embodiment of the present invention.

FIG. 3 is an exploded perspective view of a light quantity adjustment apparatus according to an embodiment of the present invention.

FIG. 4a is a cross-sectional view of the light quantity adjustment apparatus of FIG. 2.

FIG. 4b is a cross-sectional view of the light quantity adjustment apparatus of FIG. 2.

FIG. 5a is a perspective view of a blade according to an embodiment of the present invention.

FIG. 5b is a front elevational view of a blade according to an embodiment of the present invention.

FIG. 6a is a perspective view of a blade arm according to an embodiment of the present invention.

FIG. 6b is a cross-sectional view of the blade arm of FIG. 6a across line CC′.

FIG. 6c is a cross-sectional view of the blade arm of FIG. 6a across line DD′.

FIG. 7a is a perspective view of a housing according to an embodiment of the present invention.

FIG. 7b is a cross-sectional view of the housing of FIG. 7a.

FIG. 7c is a cross-sectional view of the housing of FIG. 7a.

FIG. 8a is a perspective view of a shaft according to an embodiment of the present invention.

FIG. 8b is a cross-sectional view of the shaft of FIG. 8a across line GG′.

FIG. 9a is a perspective view of a securing bush according to an embodiment of the present invention.

FIG. 9b is a cross-sectional view of the securing bush of FIG. 9a across line JJ′.

FIG. 10a is a perspective view of a core according to an embodiment of the present invention.

FIG. 10b is a cross-sectional view of a core according to an embodiment of the present invention.

FIG. 11a is a perspective view of a yoke according to an embodiment of the present invention.

FIG. 11b is a cross-sectional view of the yoke of FIG. 11a across line KK′.

FIG. 12 is a schematic diagram illustrating a light quantity adjustment apparatus in operation according to an embodiment of the present invention.

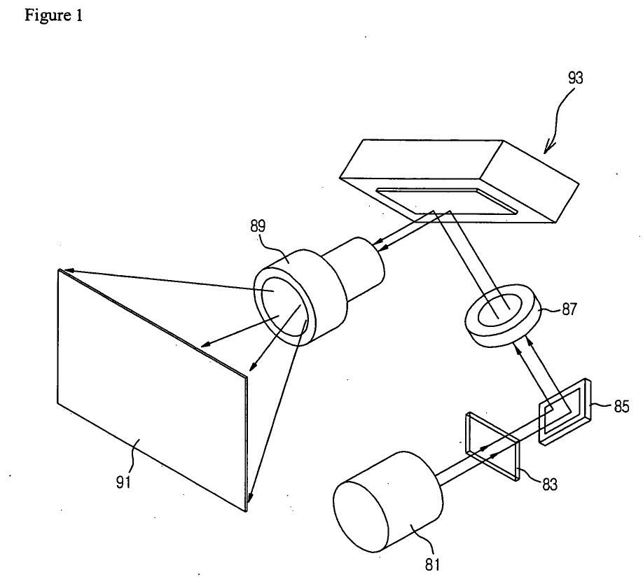

### DETAILED DESCRIPTION

Hereinafter, embodiments of the light quantity adjustment apparatus based on the present invention will be described in more detail with reference to the accompanying drawings.

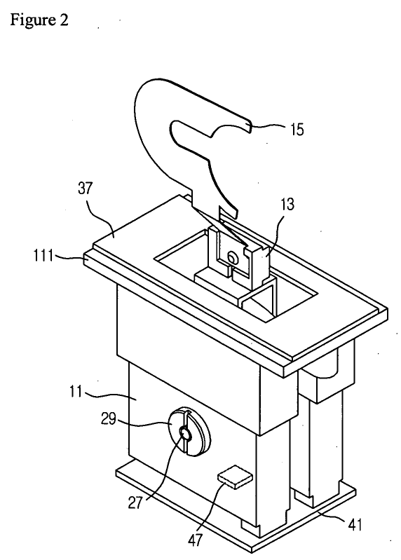

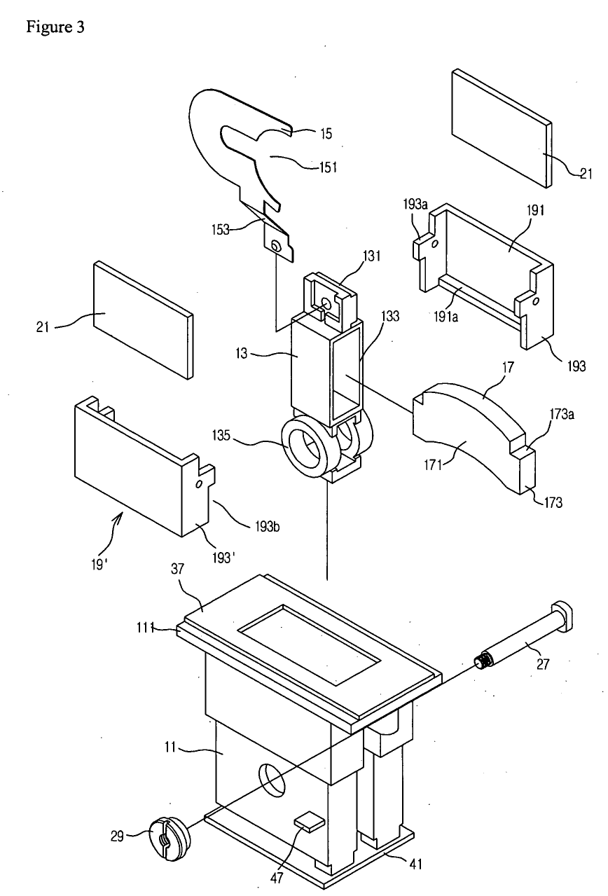

FIG. 2 is an assembled perspective view of a light quantity adjustment apparatus according to an embodiment of the present invention, and FIG. 3 is an exploded perspective view of the light quantity adjustment apparatus illustrated in FIG. 2.

Referring to FIGS. 2 and 3, a light quantity adjustment apparatus according to an embodiment of the present invention comprises a rotation part, which includes a blade arm 13 and a blade 15; a driving part, which includes driving magnets 21, a coil 45, a core 17, and a yoke 19, and which rotates the rotation part by a predetermined angle; a support part, which includes a housing 11, a shaft 27, a securing bush 29, a spring 31, bearings 33, and an adjustment bush, and which rotatably supports the rotation part; a reset part, which includes a reset magnet 23, and which sets the base position of the rotation part by interacting with the driving part; and a position detection part which includes a position magnet 25 and which detects the position of the rotation part.

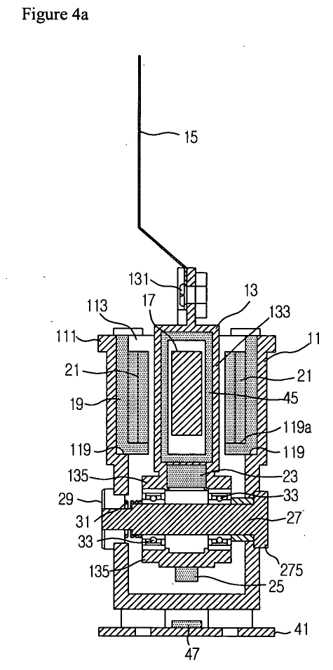

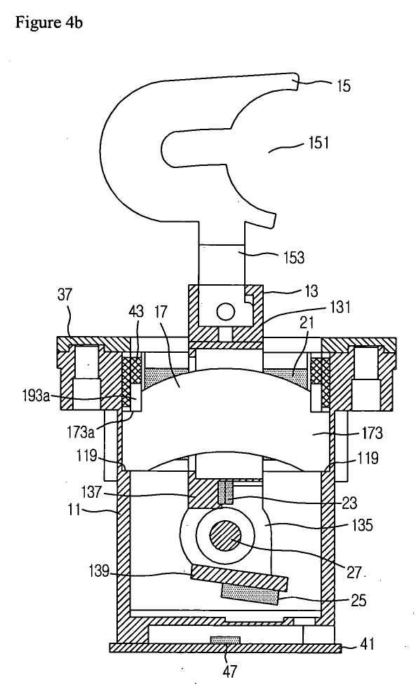

FIGS. 4a and 4b are cross-sectional views of the light quantity adjustment apparatus of FIG. 2.

Referring to FIGS. 4a and 4b, the blade 15 having an aperture 151 which adjusts light quantity is screw-joined with the blade arm 13. Also, the blade arm 13 is inserted onto the shaft 27 to be rotatably joined to the housing 11. Bearings 33 are positioned between the blade arm 13 and the shaft 27. Also, the shaft 27 has a securing bush 29 screw-joined onto one end thereof, to be inserted and secured in the housing 11, while at the other end, the shaft head 275 is inserted to the housing 11. The shaft 27 is pressed by a spring 31 in one direction, and its position is set by the adjustment bush.

The yoke 19 is placed inside the housing 11, and the driving magnet 21 is placed on the yoke 19. The coil 45 is mounted inside the blade arm 13, and a core 17 is positioned inside the coil 45. The reset magnet 23 is attached to the reset magnet mounting part 137 of the blade arm 13, and the position magnet 25 is attached to a position magnet mounting part 139.

A pad 37 is attached to the upper portion of the housing 11, and a printed circuit board 41 is attached to the lower portion. Also, a damper 43 is attached to each side of the yoke 19.

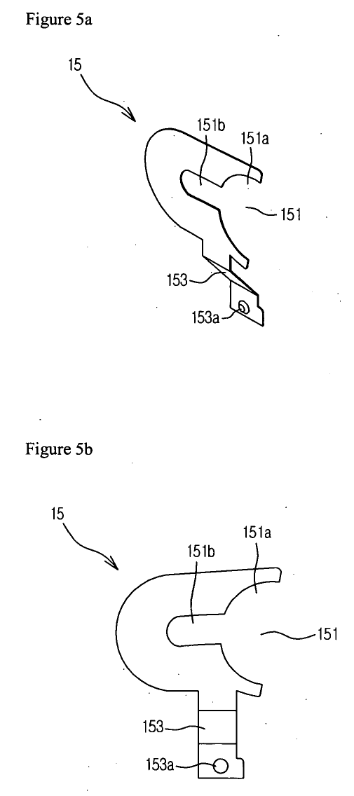

The composition of each of the rotation part, driving part, support part, reset part, and position detection part will be described below with reference to FIGS. 5 to 11.

The rotation part comprises a blade 15 having an aperture for adjusting the quantity of light from a light source, and a blade arm 13 joined with the blade 15 on which a rotational force is applied by the driving part.

FIG. 5a is a perspective view of a blade 15 according to an embodiment of the present invention, and FIG. 5b is a front elevational view of the blade 15 illustrated in FIG. 5a. The blade 15 based on a preferred embodiment of the invention has an aperture 151 for adjusting the quantity of light and a connection part 153 for joining with the blade arm 13. As light from a light source (not shown) is incident on the blade 15, it may preferably be coated in a non-lustrous, black color, to prevent scattered reflecting.

The aperture 151 rotates in minute angles, thereby adjusting the quantity of light emitted from the light source. That is, the aperture 151 has a first aperture 151a and a second aperture 151b having different radii of curvature, and through precision control of the position of the aperture 151, the quantity of light passing through the aperture 151 may be adjusted.

Although FIGS. 5a and 5b illustrate a first aperture 151a and a second aperture 151b, the present invention is not thus limited, and the number of apertures may be varied as necessary. For example, a single aperture may be used, or three or mote apertures having sequentially increasing radii of curvature may be used. Also, although in the present embodiment the aperture 151 has a semicircular shape, the shape of the apertures may be varied as necessary. For example, an aperture may have a shape of an ellipse, a triangle, a quadrilateral, or a slot.

The connection part 153 is screw-joined to the blade arm 13. The shape of the connection part 153 may be varied according to the design environment of the light quantity adjustment apparatus. A screw insertion hole 153a is formed on one end of the connection part 153, where a screw (not shown) is inserted into the screw insertion hole 153a and screw-joined with the blade arm 13.

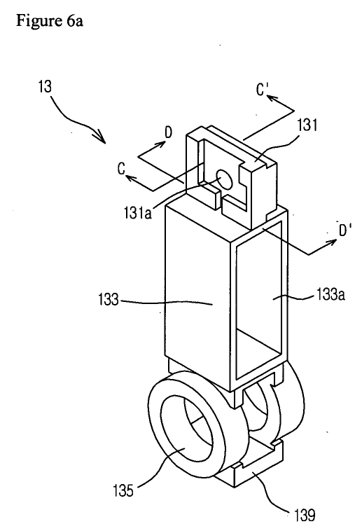

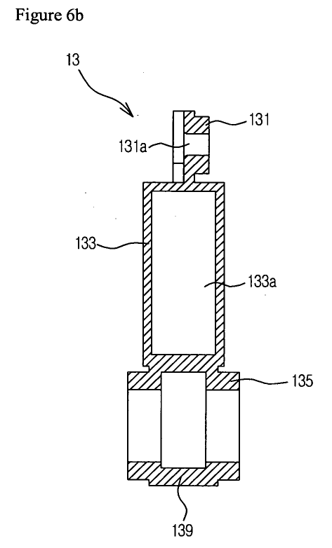

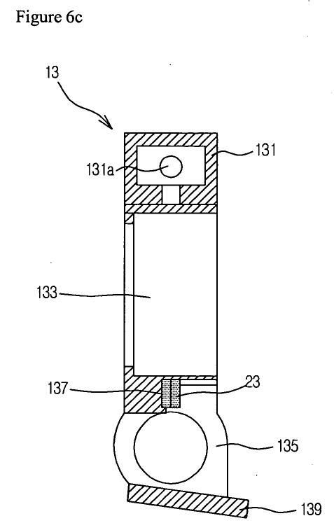

FIG. 6a is a perspective view of a blade arm 13 according to an embodiment of the present invention, and FIGS. 6b and 6c are cross-sectional views across lines CC′ and DD′ of FIG. 6a.

Referring to FIGS. 6a to 6c, the blade arm 13 according to an embodiment of the present invention comprises a blade joint part 131 which joins with the blade 15, an arm body part 133 formed on one end of the blade joint part 131, a shaft insertion part 135 formed on one end of the arm body part 133, a reset magnet mounting part 137 where the reset magnet 23 is mounted, and a position magnet mounting part 139 where the position magnet 25 is mounted. The blade arm 13 is rotated by the driving part in predetermined angles, whereby the blade 15 is rotated.

As illustrated in FIG. 6a, the blade joint part 131 is protruded from the upper portion of the arm body part 133 and has a screw insertion hole 131a. As illustrated in FIGS. 4a and 4b, a screw is inserted into the screw insertion hole 131a, whereby the blade arm 15 and the blade 13 are screw-joined. Of course, the blade 15 and the blade arm 13 may also be joined by adhesive, etc., or the blade 15 and the blade arm 13 may be formed as a single element.

The arm body part 133 has the shape of a regular hexahedron, and a cavity part 133a is formed in its center. The coil 45 and the core 17 are positioned within the cavity part 133a. As illustrated in FIG. 4a, the arm body part 133 is positioned between the driving magnets 21.

The shaft insertion part 135 is formed on one end of the arm body part 133 and is ring-shaped. The bearings 33 are inserted in the shaft insertion part 135, and the shaft 27 is inserted through the bearings 33. Thus, the blade arm 13 is rotatably supported by the shaft 27.

The reset magnet mounting part 137 is positioned between the arm body part 133 and the shaft insertion part 135. Also, the reset magnet mounting part 137 is perpendicular to the direction in which the driving magnet 21 is mounted. Further, as illustrated in FIG. 4b, only the front face of the reset magnet mounting part 137 is exposed. Therefore, only one pole of the reset magnet 23 is in interaction with the driving magnet 21. It is to be appreciated that the reset magnet mounting part 137 may be mounted in any position on the rotation part where the reset magnet 23 can interact with the driving magnet 21. Preferably, the reset magnet mounting part 137 is formed in a position close to the driving magnet 21, to increase the interactional force between the driving magnet 21 and the reset magnet 23.

The position magnet mounting part 139, as illustrated in FIG. 4b, is an inclined surface positioned at the lower surface of the shaft insertion part 135. The position magnet 25 is mounted on the position magnet mounting part 139, and a Hall sensor 47 attached to the printed circuit board 41 senses the movement of the position magnet 25. Since the blade arm 13 is rotated, the position magnet mounting part 139 is preferably formed with an inclination towards the Hall sensor 47 of the position magnet mounting part 139, so that the Hall sensor 47 may sense the movement of the position magnet 25 with greater precision. The inclination angle of the position magnet mounting part 139 may be varied according to the Hall sensor and position magnet 25, etc.

Although the blade 15 and the blade arm 13 are formed as separate elements in the present embodiment, the blade 15 and the blade arm 13 may also be formed as a single element. Also, the rotation part may have the blade 15 rotatably supported by the shaft 27 without comprising the blade arm 13. In addition, the reset magnet mounting part 137 and the position magnet mounting part 139 may be omitted depending on the compositions of the reset part and the position detection part.

The support part comprises the shaft 27 which rotatably supports the blade arm 13, the housing 11 in which the shaft 27 is inserted and secured, the securing bush 29 inserted onto the shaft 27, a spring 31, bearings 33, and an adjustment bush 35.

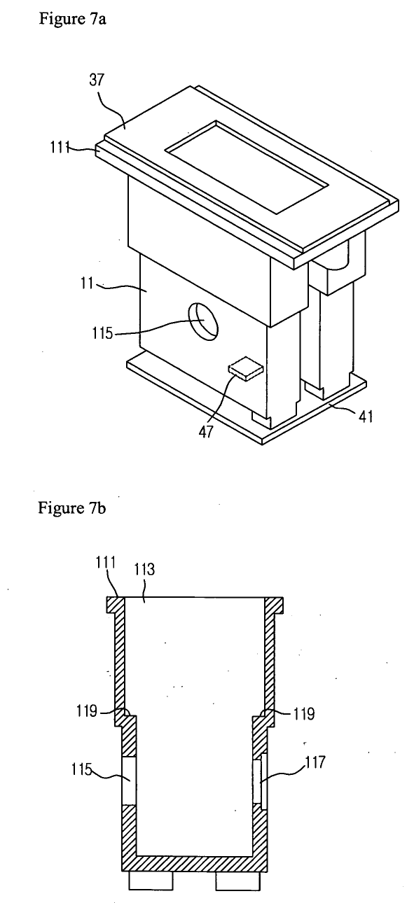

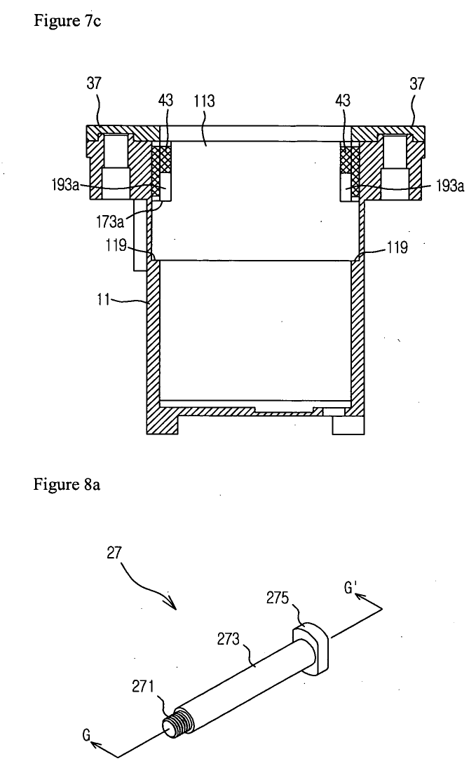

FIG. 7a is a perspective view of a housing 11 according to an embodiment of the present invention, and FIGS. 7b and 7c are cross-sectional views. Referring to FIG. 7c, the housing 11 has the shape of a regular hexahedron, is opened upwards, and includes a pad placement surface 111, an opening 113, a bush insertion hole 115, a shaft insertion hole 117, and a housing ledge 119.

The pad placement surface 111 is a surface protruded outward from and formed on the upper end of the housing 11, on which the pad 37 is placed as illustrated in FIG. 4b. The pad 37 is screw-joined at the upper portion of the housing 11 to protect the interior of the housing 11. The opening 113 is a hole formed on the upper end of the housing 11, and the interior of the housing 11 is open by means of the opening 113.

The bush insertion hole 115, as illustrated in FIG. 7a, is a hole formed on one side of the housing 11. The securing bush 29 is inserted and secured in the bush insertion hole 115. The shaft insertion hole 117, as illustrated in FIG. 7b, is formed on the housing 11 in a position opposite the bush insertion hole 115. The shaft head 275 of the shaft 27 is inserted in the shaft insertion hole 117. The bush insertion hole 115 and the shaft insertion hole 117 may be circular as illustrated in FIGS. 7a to 7c, or may have any of a variety of shapes such as an ellipse or a quadrilateral, etc.

The housing ledge 119, as illustrated in FIGS. 4a and 4b, is protruded inward by a certain length in the inner perimeter of the housing 11. The housing ledge 119 is formed along all surfaces of the inner perimeter of the housing 11. Thus, the yoke 19, as illustrated in FIG. 4a, or the core 17, as illustrated in FIG. 4b, is placed on the housing ledge 119.

A printed circuit board 41 is attached to the lower surface of the housing 11, as illustrated in FIG. 4b. A Hall sensor 47 is attached to the printed circuit board 41. The housing 11 is preferably manufactured by injection molding, to reduce manufacturing costs.

The housing 11 secures the shaft 27, and houses the rotation part, driving part, support part, reset part, and position detection part. The housing 11 may be implemented in any composition such that can support the shaft 27. For example, the shaft 27 may be supported using a hinge structure.

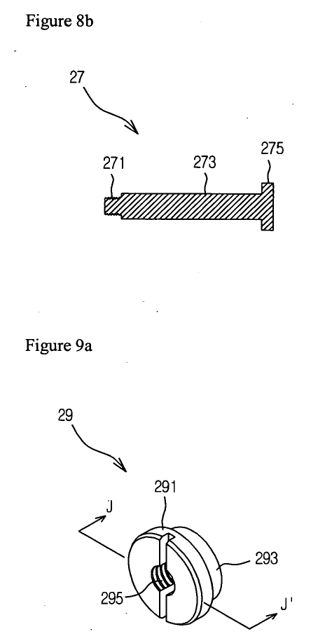

FIG. 8a is a perspective view of a shaft 27 according to an embodiment of the present invention, and FIG. 8b is a cross-sectional view across line GG′ of FIG. 8a. The shaft 27 according to an embodiment of the present invention comprises a screw part 271, a shaft body 273 extending from the screw part 271, and a shaft head 275 formed on one end of the shaft body 273.

The screw part 271 is screw-joined with the thread 295 of the securing bush 29. As illustrated in FIG. 4a, the spring 31, bearings 33, and adjustment bush, from the left, are inserted sequentially onto the shaft body 273. Also, the shaft head 275 is inserted in the shaft insertion hole 117 of the housing 11.

FIGS. 9a and 9b are a perspective view of a securing bush 29 according to an embodiment of the present invention and a cross-sectional view across line JJ′. Referring to FIGS. 9a and 9b, the securing bush 29 comprises a bush head 291, a bush body 293, and a thread 295. The securing bush 29 is inserted into the bush insertion hole 115 of the housing 11, and is screw-joined with the shaft 27 to firmly secure the shaft 27.

The bush head 291 is ring-shaped and is connected with the bush body 293. The bush head 291, as illustrated in FIG. 4a, is exposed at the perimeter of the housing 11. The bush body 293 is inserted and secured in the bush insertion hole 115 of the housing 11. The thread 295 is screw-joined with the screw part 271 of the shaft 27.

Although in the present embodiment the end of the shaft 27 is secured using a securing bush 29 on which a thread 295 is formed, the present invention is not thus limited, and any composition may be used which can secure the shaft 27. For example, a composition may be used in which a thread is formed on the inner perimeter of the bush insertion hole 117 with the shaft 27 screw-joining directly with the bush insertion hole.

The spring 31, as illustrated in FIG. 4a, is inserted onto the shaft 27 and is positioned between the shaft insertion part 135 of the blade arm 13 and the securing bush 29. Thus, the spring 31 applies pressure on the blade arm 13 in one direction, and since the adjustment bush is inserted at the other side of the blade arm 13, the blade arm 13 is secured with pressure applied on it by the spring 31. Thus, the blade arm 13 is prevented from moving on the shaft 27 by the spring 31 and the adjustment bush, and as illustrated in FIG. 4a, is positioned between the driving magnets 21 which are positioned to be opposite each other.

The bearings 33, as illustrated in FIG. 4a, are positioned between the shaft insertion hole 117 and the shaft 27, to allow smooth rotation for the shaft 27. The bearings 33 may be ball bearings or roller bearings.

Although in the present embodiment the rotation part comprises the shaft 27 and a housing 11 supporting the shaft 27, the present invention is not thus limited, and any composition may be used with which the rotation part can be rotatably supported. For example, a composition may be used where the rotation part has a hinge structure joined to the shaft. Also, when the driving part is a step motor, the rotation part may be joined directly to the rotational axis of the step motor.

The driving part rotates the rotation part in predetermined angles, and the driving part comprises driving magnets 21, a coil 45, a core 17, and a yoke 19.

The driving magnets 21, as illustrated in FIG. 4a, are mounted in a pair on the inner surface of the yoke 19, where the surfaces facing each other have the same pole. The magnetic field generated by the driving magnets 21 passes through the coil 45 positioned inside the cavity part 133a. Here, when a current is supplied to the coil 45, an electromagnetic force is applied on the coil according to Fleming's Left Hand Rule. The magnetic field generated by the driving magnets 21 is further concentrated on the coil 45 by the yoke 19 and the core 17.

The coil 45 is positioned inside the cavity part 133a, and is connected to the printed circuit board 41 by a flexible printed circuit board. Although the coil 45 may be connected directly to the printed circuit board 41, a connection using a flexible printed circuit board allows a more stable supply of current.

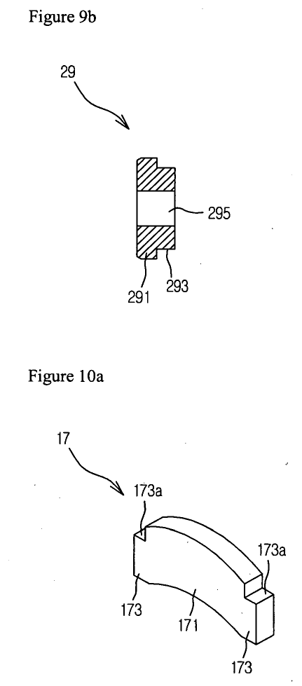

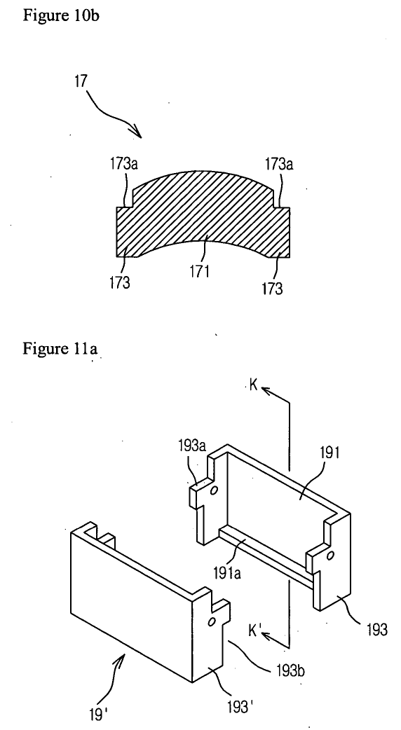

FIG. 10a is a perspective view of a core 17 according to an embodiment of the present invention, and FIG. 10b is a cross-sectional view of the core 17.

The core 17 comprises an arc-shaped core body 171 and a core protrusion part 173 formed on either end of the core body 171. The core 17 is positioned inside the coil 45 and concentrates the magnetic field generated by the driving magnets 21 on the coil 45. Therefore, the core 17 is preferably manufactured from a metal that is high in magnetic permeability, such as iron or nickel.

The core body 171, as illustrated in FIGS. 4a and 4b, is positioned inside the coil 45. Since the coil 45 and the blade arm 13 are rotated, the core body 171 preferably has an arc shape, so that the rotation of the blade arm 13 is not obstructed by the core body 171. Also, it is further preferable that the radius of curvature of the core body 171 be equal or substantially equal to the radius of rotation of the blade arm 13.

The core protrusion parts 173 protrude from both ends of the core body 171, and core ledges 173a are formed between the core body 171 and the core protrusion parts 173. The core protrusion parts 173, as illustrated in FIG. 4b, are placed on the housing ledge 119.

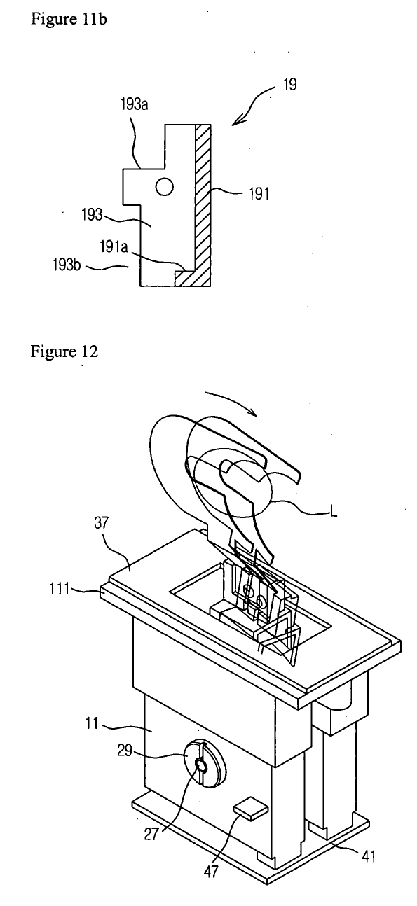

FIG. 11a is a perspective view of a yoke according to an embodiment of the present invention, and FIG. 11b is a cross-sectional view across line KK′ of FIG. 11a.

Referring to FIGS. 11a and 11b, a yoke 19 according to an embodiment of the present invention has a yoke body part 191 and a yoke side part 193 protruding from either end of the yoke body part 191. The yoke 19 is composed of a pair of halves 19, 19′ identical in shape. Similar to the core 17, the yoke 19 concentrates the magnetic field generated by the driving magnets 21 on the coil 45. Therefore, the yoke 19 is also preferably manufactured from a metal that is high in magnetic permeability, such as iron or nickel.

A cross section of the yoke body part 191, 191′ has a “┘” shape. The yoke body parts 191, 191′, as illustrated in FIG. 4a, are placed on the housing ledge 119, and the driving magnets 21 are positioned on the magnet placement parts 191a, 191a′ of the yoke body parts 191, 191′. The yoke body parts 191, 191′ are preferably formed to allow a press fit inside the housing 11. Also, the height of the yoke body parts 191, 191′ is equal to the length from the housing ledge 119 to the upper end of the housing 11.

The yoke side parts 193, 193′ protrude perpendicularly from both ends of the yoke body parts 191, 191′ and have the same shape for the left and right sides. The yoke side parts 193, 193′ have yoke protrusions 193a, 193a′. Also, the joining of a pair of yokes 19, 19′ forms yoke insertion grooves 193b. The yoke protrusions 193a, 193a′, as illustrated in FIG. 4b, are placed on the core ledges 173a of the core 17, respectively. Also, the core protrusion parts 173 of the core 17 are inserted in the yoke insertion grooves 193b.

As illustrated in FIG. 4b, dampers 43 are positioned on the yoke protrusions 193a, 193a′. The dampers 43 not only prevent noises caused by the blade arm 13 rotating and colliding with the yoke protrusions 193a, 193a′, but also act as stoppers to prevent excessive rotation of the blade arm 13. The dampers 43 are preferably manufactured from a light, shock-absorbing material, such as plastic resin.

As set forth above, although the present embodiment used a voice coil motor (VCM) for the driving part, the present invention is not thus limited, and any composition may be used that can rotate the rotation part by a predetermined angle. For example, a step motor or an ultrasonic motor may be used for the driving part.

The reset part sets the base position of the rotation part by means of the interaction with the driving magnets 21 of the driving part. The reset part comprises a reset magnet 23.

The reset magnet 23 is attached to the reset magnet mounting part 137 of the blade arm 13. When the reset magnet 23 is mounted, as illustrated in FIG. 4b, only one side of the reset magnet 23 is exposed to the driving magnets 21. Also, the reset magnet 23 is magnetized in a direction perpendicular to the driving magnets 21. As illustrated in FIG. 4b, when inner sides of the driving magnets 21 are N-poles and the S-pole of the reset magnet 23 is exposed, the interaction between the reset magnet 23 and the driving magnets 21 causes the blade arm 13 to rotate counter-clockwise. Therefore, when a current is not supplied to the coil 45, the blade arm 13 is always slanted to the left side of the housing 11.

Although the present embodiment uses a reset magnet 23 for the reset part, the present invention is not thus limited, and any composition may be used which can return the rotation part to its original state when there is no current supplied to the coil 45. For example, a torsion spring may be inserted onto the shaft 27 to elastically press the blade arm 13.

The position detection part senses the position of the rotation part. The position detection part comprises a position magnet 25 mounted on the blade arm 13.

The position magnet 25, as illustrated in FIG. 4b, is attached to the position magnet mounting part 139 formed on the lower surface of the blade arm 13. The position magnet 25 is adjacent to the bottom surface of the housing 11, and on the bottom surface of the housing 11 is positioned the printed circuit board 41, on which a Hall sensor 47 is mounted. Thus, the Hall sensor 47 senses the position of the position magnet 25. Also, since the position magnet 25 is attached with an inclination towards the Hall sensor 47, the Hall sensor 47 may sense position changes due to rotation of the position magnet 25 with greater precision.

The Hall sensor 47, after detecting the position of the blade arm 13, transfers a signal through the printed circuit board 41 to a control part (not shown). Then, after the control part identifies the position of the rotation part, it re-inputs a corresponding control signal to rotate the rotation part by the required angle.

Although in the present embodiment a Hall sensor is used to detect the position of the rotation part, the present invention is not thus limited, and any composition may be used that can detect the position of the rotation part. For example, an angle sensor may be used to detect the position of the rotation part.

The operation of a light quantity adjustment apparatus according to an embodiment of the invention will be described below.

FIG. 12 is a schematic diagram illustrating the case where light L is incident on the aperture 151 of a light quantity adjustment apparatus according to an embodiment of the present invention.

The light L emitted from the light source (not shown) passes through the aperture 151 of the blade 15, and as the size of the aperture 151 is smaller than the size of the light L, a portion of the light L is blocked. Here, the position of the blade 15 and blade arm 13 is identified by the Hall sensor 47, which reacts to the movement of the position magnet 25, and transferred to the control part (not shown). If it is needed to further increase the quantity of light projected on the screen, a signal is sent from the control part to the printed circuit board 41 to operate the driving part.

When the control signal from the control part is inputted to the printed circuit board 41, a current is supplied to the coil 45. Here, as the magnetic field generated by the driving magnets 21 passes through the coil 45, a force is applied on the coil 45 due to the electromagnetic interaction between the magnetic field and the electric field generated by the coil. This force causes the blade arm 13 and the blade 15 to rotate. The rotation angle and rotation speed of the blade 15 and the blade arm 15 are controlled by adjusting the current supplied to the coil 45.

When the aperture 151 rotates counter-clockwise due to the rotation of the blade 15, the size of the aperture 151 through which the light L may pass is increased. Thus, the quantity of light passing through the aperture 151 is increased. To return the aperture 151 to its original position, the current supply to the coil 45 is stopped, at which the reset magnet 23 and the driving magnet 21 interact to return the blade arm 13 to its original state.

According to the present invention comprised as above, the following benefits may be obtained.

The invention may provide a light quantity adjustment device which not only improves contrast ratio but also allows a clearer picture quality by adjusting the quantity of light projected from an image projection device.

The invention may use a reset magnet to automatically return the blade to its original position as well as a position detection part to identify the position of the blade, so that the blade may be controlled with greater precision.

With the present invention, a plurality of apertures having different radii of curvature may be formed sequentially on the blade, so that the light quantity may be controlled with greater precision.

With the present invention, the blade may be treated to have a non-lustrous black color, so that the scattering of light may be avoided.

With the present invention, the position magnet may be positioned with an inclination towards the Hall sensor, so that the position of the rotation part may be identified with greater precision.

With the present invention, one side of the blade arm may be secured by an adjustment bush and the other side may be pressed by a spring, so that random movement may be prevented of the blade arm on the shaft.

With the present invention, bearings may be positioned between the blade arm and the shaft, so that the blade arm may rotate smoothly.

With the present invention, dampers may be attached to the yoke to prevent noises caused by collisions between the blade arm and the yoke, as well as to prevent excessive rotation of the blade arm.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention.

What is claimed is:

1. A light quantity adjustment apparatus comprising:
a rotation part having an aperture for adjusting the quantity of light from a light source;
a support part rotatably supporting the rotation part;
a driving part rotating the rotation part left and right in a predetermined angle;
a reset part for setting a base position; and
a position detection part detecting the position of the rotation part.

2. The light quantity adjustment apparatus of claim 1, wherein the rotation part comprises:
a blade having the aperture formed thereon; and
a blade arm joined with the blade and having a rotational force applied thereon by the driving part.

3. The light quantity adjustment apparatus of claim 2, wherein the support part comprises:
a housing; and
a shaft secured to the housing and rotatably supporting the blade arm.

4. The light quantity adjustment apparatus of claim 3, wherein the driving part comprises:
a coil joined to the blade arm; and
a driving magnet joined to the housing and generating a magnetic field passing through the coil.

5. The light quantity adjustment apparatus of claim 4, wherein the reset part comprises a reset magnet joined to the rotation part and magnetically interacting with the driving magnet.

6. The light quantity adjustment apparatus of claim 5, wherein the position detection part comprises:
a position magnet joined to the rotation part; and
a Hall sensor secured to the housing.

7. The light quantity adjustment apparatus of claim 6, wherein a plurality of apertures having different radii of curvature are sequentially formed on the blade.

8. The light quantity adjustment apparatus of claim 6, wherein a surface of the blade is treated to be black and non-lustrous.

9. The light quantity adjustment apparatus of claim 6, wherein the blade arm comprises:
an arm body part,
a blade joint part formed on one end of the arm body part and joining the blade; and
a shaft insertion part formed on the other end of the arm body part and having the shaft joined thereto.

10. The light quantity adjustment apparatus of claim 9, wherein the blade arm is formed on the lower end of the shaft insertion part, and further comprises a position magnet mounting part having the position magnet mounted thereon.

11. The light quantity adjustment apparatus of claim 10, wherein the position magnet mounting part is inclined in a predetermined angle towards the Hall sensor.

12. The light quantity adjustment apparatus of claim 6, wherein the support part comprises:
an adjustment bush inserted into one end of the shaft to be positioned between the blade arm and the housing; and
a spring inserted into the other end of the shaft and applying pressure on the blade arm.

13. The light quantity adjustment apparatus of claim 6, wherein
the support part additionally comprises a securing bush,
the shaft comprises a shaft body; a screw part formed on one end of the shaft body and screw-joining the securing bush; and a shaft head formed on the other end of the shaft body,
and the housing comprises a bush insertion hole having the securing bush inserted therein; and a shaft insertion hole having the shaft head inserted therein.

14. The light quantity adjustment apparatus of claim 9, wherein
a bearing is positioned between the shaft insertion part and the shaft.

15. The light quantity adjustment apparatus of claim 9, wherein
the arm body part has a cavity part,
the coil is positioned within the cavity part,
and the driving part comprises a core positioned within the coil in the rotational direction of the blade arm, and a yoke positioned adjacent to the driving magnet in a direction parallel to the core.

16. The light quantity adjustment apparatus of claim 15, wherein
the housing has a housing ledge on the inner perimeter thereof,
and the core and the yoke are placed on the housing ledge.

17. The light quantity adjustment apparatus of claim 15, wherein
the yoke is composed of a pair of halves each comprising a yoke body part having a magnet placing part, and yoke side parts protruding perpendicularly from both ends of the yoke body part,
the core has a core body part, and core protrusion parts formed on both ends of the core body part with core ledges as boundaries,
and the yoke side parts have yoke protrusions configured to be placed on the core ledges, and yoke insertion grooves having the core protrusion parts inserted therein.

18. The light quantity adjustment apparatus of claim 17, wherein the core body part has an arc shape.

19. The light quantity adjustment apparatus of claim 17, wherein a damper is attached to each of the yoke protrusions.

20. The light quantity adjustment apparatus of claim 19, wherein the damper is formed of plastic resin.

21. The light quantity adjustment apparatus of claim 6, wherein the reset magnet is magnetized in a direction perpendicular to the driving magnet and has only one pole exposed to the exterior.

22. The light quantity adjustment apparatus of claim 6, wherein the position detection part has a printed circuit board having the Hall sensor and attached to the lower portion of the housing, and the printed circuit board is electrically connected to the coil by a flexible printed circuit board.

23. The light quantity adjustment apparatus of claim 6, wherein the housing is formed by compression sintering.
